(19) United States
(12) Patent Application Publication
(10) Pub. No.: US 2023/0129978 A1
(43) Pub. Date: Apr. 27, 2023

(54) METHOD FOR CAUSAL INFERENCE BASED ON COLLECTIVE MOVEMENTS OF ACTIVE GROUP

(71) Applicant: UNIVERSITY OF SOUTH CHINA, Hengyang (CN)

(72) Inventors: Yaping WAN, Hengyang (CN); Xiaohua YANG, Hengyang (CN); Zhenghai LIU, Hengyang (CN); Tiejun ZENG, Hengyang (CN); Yu MAO, Hengyang (CN); Panpan JIANG, Hengyang (CN); Mingxing NIE, Hengyang (CN); Chunping OUYANG, Hengyang (CN); Chaofeng WANG, Hengyang (CN); Lifang ZHOU, Hengyang (CN)

(21) Appl. No.: 17/888,547

(22) Filed: Aug. 16, 2022

(30) Foreign Application Priority Data
Oct. 25, 2021 (CN) 2021112388200

(51) Int. Cl. G06N 5/04; G06K 9/62; G06K 9/00

(52) U.S. Cl. CPC G06N 5/04; G06K 9/6215; G06K 9/0051

(57) ABSTRACT

Disclosed is a method for causal inference based on collective movement of active group, comprising obtaining leader time series and follower time series of the collective movement of the active group; obtaining fixed time lag, obtaining optimal fixed time lag based on the fixed time lag, obtaining aligned time lag series based on the leader time series and follower time series; relaxing the fixed time lag, updating the optimal fixed time lag based on the relaxed results; obtaining optimal aligned time lag series based on the aligned time lag series and the updated optimal fixed time lag; distorting the leader time series and the follower time series based on the optimal aligned time lag series; performing Grange Causality inference on the distorted leader time series and follower time series to obtain results of Granger Causality inference of the collective movement of the active group.

### CROSS-REFERENCE TO RELATED APPLICATIONS

This application claims priority to Chinese Patent Application No. 202111238820.0, filed on Oct. 25, 2021, the contents of which are hereby incorporated by reference.

### TECHNICAL FIELD

The present application relates to the technical field of causal inference of time series, and in particular to a method for causal inference based on collective movements of an active group.

### BACKGROUND

Leadership phenomena in the collective movement of an active group, though complex in terms of microscopic behavior, is simple at the level of macroscopic behavior. Therefore, a hydrodynamics-like approach is adopted in some study to describe the collective movements of the active group, including Navier-Stokes equations. The hydrodynamics-like approach, which takes the moving population as a hydrodynamic field involving velocity fields and individual number density fields that evolve over time, not only provides a better description of the following relations of the leadership phenomena of the active group, but also allows for easy derivation of concise analytical solutions using differential equations as a tool of mathematical description. Nevertheless, this hydrodynamics-like approach averages individual behavior in a statistical way and does not adequately reflect small-scale local phenomena. Cellular automaton, a method proposed by Stanislaw Ulam and John von Neumann in the 1940s, divides space into tessellated squares, where individuals can move or not move with a certain probability towards a similar grid. This method has won popularity among researchers owing to its ability to discretize space at the microscopic level, its high degree of abstraction, and its ability to capture the main features of the simulated object. Despite its characteristics of efficient computation and ease of analysis in addition to ingenious abstraction, this approach of cellular automaton does not allow for sufficient consideration of the microscopic behavior of individuals, making it unable to provide a realistic portrayal of leadership phenomena in the spatial movement of active group. However, the description on leadership phenomena of collective movements of active group is rather sketchy as a result of the fact that a number of different social forces tend to reproduce the same macroscopic phenomena.

Massive data of time series are available in the collective movements of active group. The approach of using causal inference of time series to explore the occurrence mechanism behind the leadership phenomenon of active group can not only provide a micro-level understanding of the strength of active individuals responding to the leadership intervention of the specific group environment they are in, and understanding of the conditions for the occurrence of large-scale collective behavior, but more importantly, it can also provide insight and guidance for practical production activities and help to develop solutions to relevant problems. For example, robofish can be released in marine fishing operations to lure fish into traps at a suitable pace after knowing the pattern of herding behavior of fish foraging, the fishing efficiency can therefore be improved by making full use of the universal following time-delay of fish. In the year of 1969, Clive Granger, the famous Nobel Prize winner in economics, first quantified and introduced time series into causal inference, and the concept he proposed is now widely known as Granger Causality. The Granger Causality inference is defined and approached by assuming that the cause time series affects the outcome time series with a fixed time delay (time delay can also be referred to as time lag). In 2019, Chainarong Amornbunchornvej et al. proposed a variable-lag Granger Causality (VL Granger Causality) inference to better solve the problem of causal detection between time series influenced by arbitrary time lag by relaxing the assumption of fixed time lag in traditional Granger Causality to variable time lag.

In the case of collective movements of active group, one individual may suddenly change direction or move faster upon finding food or encountering an enemy, thus making itself the leader of the group and attracting other individuals in the group. Although VL Granger Causality inference takes into account the correspondence of variable time lags at each time point in the causal detection of the active group leadership phenomenon, the precision of inference is still low. It is because that: VL Granger Causality inference is corrected for the average time delay (later called the optimal fixed time lag) when ‘aligning’ the two time series, and some leadership relationships with insignificant time lags between leaders and followers can affect the screening of the optimal fixed time lag for the whole group; specifically, followers, on one hand, tend to move in the same direction as the leader, not simply in a position behind the leader, and given that many followers from time to time will move in front of the leader while still following the leader, the time lag will be offset by the time lag of the leadership phenomenon where the follower really walks behind the leader, i.e. the overall time lag tends to be neutralized; on the other hand, the leadership message spreads only gradually among the active group, and attracts more followers over time, not as simply as the leader attracts all followers immediately at the beginning; with time, the previous leaders and followers have gradually merged into a leadership group to the followers who perceived the leadership phenomenon later, and the leadership group and the new followers will continue to deepen the time lag neutralization.

### SUMMARY

In view of solving the above-mentioned problems existing in the prior art, such as the overall time lag of the active group in collective movement tends to be neutralized and leads to the non-obviousness of the optimal fixed time lag, the present application provides a method for causal inference based on collective movement of the active group, enabling effective inference of leaders in collective movement of the active group. The method may be applied in marine fishing operations in helping to release robofish and induce fish into traps at a suitable pace, to improve fishing efficiency.

To achieve the above technical objectives, the present application provides the following technical schemes, including:

obtaining leader time series and follower time series for collective movements of the active group;

obtaining a fixed time lag, obtaining an optimal fixed time lag based on the obtained fixed time lag; obtaining an aligned time lag series based on the obtained leader time series and the obtained follower time series; relaxing the obtained fixed time lag, updating the obtained optimal fixed time lag based on a result of relaxing; obtaining an optimal aligned time lag series based on the obtained aligned time lag series and the updated optimal fixed time lag;

distorting the leader time series and the follower time series based on the optimal aligned time lag series, performing Granger Causality inference on the distorted leader time series and the follower time series, and obtaining a result of Granger Causality inference of active group collective movement; obtaining a leader movement trajectory based on the result of Granger Causality inference of active group collective movement, releasing a robofish to learn the leader movement trajectory, and setting pace of the robofish to achieve fish harvesting.

Optionally, obtaining leader time series and follower time series for collective movements of active group includes a process as follows:

obtaining a number of initial leader time series and a number of initial follower time series of the movements of the active group, and obtaining the leader time series and follower time series by aggregating the initial leader time series and follower time series, respectively;

The initial leader time series and the initial follower time series include parameters of movement direction and acceleration.

Optionally, the optimal fixed time lag is obtained specifically by:

distorting the leader time series based on the fixed time lag, performing intercorrelation degree analysis on the follower time series and the distorted leader time series, and obtaining the optimal fixed time lag based on the results of the intercorrelation degree analysis;

the optimal fixed time lag is the fixed time lag corresponding to the maximum degree of intercorrelation in the results of the intercorrelation degree analysis.

Optionally, the aligned time lag series is obtained by:

normalizing the leader time series by means of a dynamic time warping (DTW) algorithm, aligning the normalized leader time series with the follower time series, performing a time lag calculation on the follower time series and the normalized leader time series based on an alignment result, and obtaining the aligned time lag series based on a result of the time lag calculation.

Optionally, relaxing obtained fixed time lag is preceded by:

distorting the leader time series by fixed time lag, measuring similarity of the follower time series and the distorted leader time series, constructing a correlation function based on the follower time series and the measured similarity, determining numerically based on the constructed correlation function and obtaining a determination result;

relaxing the fixed time lag if the determination result satisfies a determination condition; otherwise, performing no relaxing and directly obtaining the optimal aligned time lag series based on the aligned time lag series and the optimal fixed time lag.

Optionally, updating the obtained optimal fixed time lag includes:

constructing a relaxing coefficient, ranking fixed time lags according to absolute values of the results of intercorrelation degree analysis based on the relaxing coefficient to obtain a relaxed time lag series, where the relaxed time lag series includes several relaxed time lags; and

selecting a smallest relaxed time lag in a positive range of the relaxed time lag series to update the optimal fixed time lag.

Optionally, updating the optimal fixed time lag is further preceded by:

determining the relaxed time lag based on the relaxed time lag series and updating the optimal fixed time lag is a number of positive numbers in the relaxed time lag is greater than a number of negative numbers in the relaxed time lag; and

otherwise, performing no updating on the optimal fixed time lag and obtaining the optimal aligned time lag series directly based on the aligned time lag series and the optimal fixed time lag.

Optionally, performing Granger Causality inference on the distorted leader time series and the follower time series includes:

performing residual variance comparison based on distorted results for Granger Causality inference, and obtaining Granger Causality inference results for collective movement of active groups.

Optionally, performing Granger Causality inference on the distorted leader time series and the follower time series is further followed by:

obtaining a following closeness of followers to leaders by measuring the similarity on the distorted results, and supplementing the results of Granger Causality inference for the collective movement of active group based on the following closeness.

The present application achieves the technical effect as follows:

in the technical scheme provided by the present application, the aligned time lag series is obtained by performing DTW algorithm on the original time series, and by setting the fixed time lag, the original time series is distorted by the fixed time lag, the distorted time series and the undistorted time series are analyzed for the correlation degree to obtain the optimal fixed time lag; the fixed time lags are processed by relaxing coefficients, and the new relaxed time lags are selected to update the optimal fixed time lag through the relaxed time lag obtained by processing, and the optimal aligned time lag series is obtained by integrating the updated optimal fixed time lag and the aligned time lag series, and the original time series is distorted through the optimal aligned time lag series, and the distorted results are subjected to Granger Causality inference, and the causal relationship of the collective movement of the active group can be effectively obtained; the present application relaxes the selection of the optimal aligned time lag series for the optimal fixed time lag, thus significantly improving the detection of active leadership phenomena; it is therefore possible to understand the strength of active individual responding to leadership interventions in the specific group environment they are in, and to understand the conditions for the occurrence of large-scale collective behavior at the micro level, and such an approach can be widely applied in marine fishing operations, where the fish are trained to obtain the movement trajectory of the characteristic group of fish firstly, then the active group leadership characteristics of the fish class are obtained according to the movement trajectory, and trained robofish are released to simulate the movement trajectory of the fish leader based on the obtained leadership characteristics, followed by setting a suitable pace so as to induce the fish into a trap, and the fishing efficiency is improved accordingly. The approach provided in the present application can serve as a source of inspiration and guidance for the production of real-life and help to develop solutions to relevant problems.

### BRIEF DESCRIPTION OF THE DRAWINGS

In order to more clearly illustrate the technical schemes in the embodiments or prior art of the present application, the following is a brief description of the accompanying drawings to be used in the embodiments, and it is obvious that the following description of the accompanying drawings are only some embodiments of the present application; for the person of ordinary skill in the art, other drawings may be obtained according to these accompanying drawings without creative labor.

FIG. 1 shows a schematic diagram of a process of the method provided by an embodiment of the present application.

FIGS. 2A and 2B illustrate a schematic diagram of dynamic time warping (DTW) algorithm aligning time series provided by an embodiment of the present application.

FIGS. 3A and 3B shows a schematic diagram of the cross-correlation function (CCF) image and relaxation of the optimal fixed time lag provided by an embodiment of the present application.

FIG. 4 illustrates a schematic diagram of obtaining the optimal aligned time lag series provided by an embodiment of the present application.

FIGS. 5A and 5B show a schematic diagram of the necessity of correction in obtaining the optimal fixed time lag in the optimal aligned time lag series, provided by an embodiment of the present invention.

### DETAILED DESCRIPTION OF THE EMBODIMENTS

The technical schemes in the embodiments of the present application will be clearly and completely described below in conjunction with the accompanying drawings in the embodiments of the present application, and it is clear that the described embodiments are only a part of the embodiments of the present application, and not all of them. Based on the embodiments in the present application, all other embodiments obtained by a person of ordinary skill in the art without making creative labor fall within the scope of protection of the present application.

In order to solve the problems existing in the prior art where the overall time lag of the active group during collective movement would to be neutralized during collective movement leading to the insignificance of the optimal fixed time lag, the present application provides the following schemes.

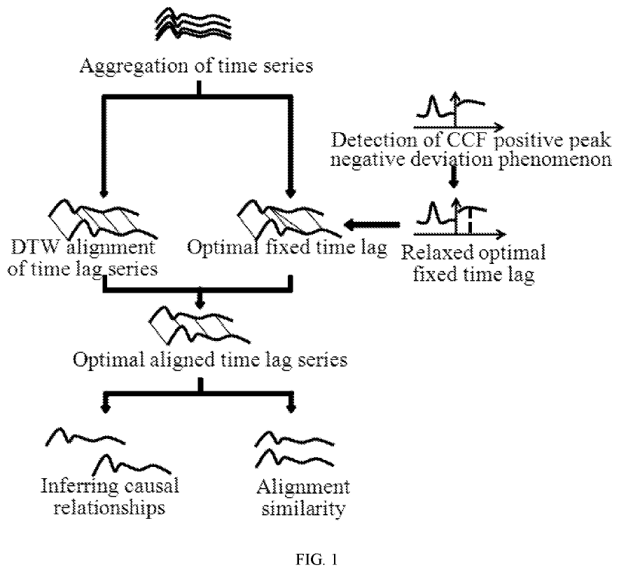

As described in FIG. 1, the present application provides a method for causal inference based on collective movements of active group, which focuses on achieving causal inference of leadership phenomena in collective movements of active group by improving the Granger Causality inference method with variable time lag into a Granger Causality inference method with relaxed time lag. The method of inference mainly includes aggregating time series, obtaining optimal aligned time lag series, and performing causal inference; considering that the overall time lag of the active group tends to be neutralized during collective movement and leads to the insignificance of the optimal fixation time lag, accordingly, the present application relaxes the selection of the optimal fixed time lag in terms of selecting the optimal aligned time lag series, thus significantly improving the detection of leadership phenomena in active group; therefore, not only can the strength of active individuals responding to leadership interventions in the particular group environment in which they live be understood at the micro level, but also the conditions under which large-scale collective behavior occurs, and more importantly, the method may provide insight and guidance for real-life production activities and help to develop solutions to relevant problems.

The present application constructs a method for causal inference based on collective movements of active group—a Granger Causality inference method with variable relaxed time lag, where the method specifically includes:

step I, aggregating multiple leader time series and follower time series into one leader time series and one follower time series respectively, so as to simplify the study of subsequent causal inference;

where X(t)∈R is the value of the time series X=(X(1), . . . , X(t), . . . ) at moment t, there is a set of time series X={X₁, . . . }, and an aggregated time series is obtained by averaging each step of these time series, and

$$agg ( X ) = ( \frac{1}{\vert X \vert} {\sum }_{i = 1}^{\vert X \vert} {X}_{i} ( 1 ) , … , \frac{1}{\vert X \vert} {\sum }_{i = 1}^{\vert X \vert} {X}_{i} ( t ) , … ) ;$$

by aggregating time series, multiple time series can be aggregated into a single time series to make the study more streamlined, therefore the study of causality between two sets of time series can be reduced to the study of causality between two time series;

step II, obtaining the optimal fixed time lags and dynamic time warping (DTW) aligned (DTW-aligned) time lag series of the leader time series and the follower time series respectively; relaxing the optimal fixed time lag to a new optimal fixed time lag if the cross-correlation function (CCF) images of the two time series show positive peaks and negative bias phenomenon, followed by a trade-off between the DTW-aligned time lag series and the new optimal fixed time lag to obtain the optimal aligned time lag series; the main technical idea is:

obtaining the DTW-aligned time lag series of the two time series firstly, and using the optimal fixed time lag to correct the DTW-aligned time lag series in view of the obvious time lag of the two time series; in obtaining the optimal fixed time lag, given that many followers from time to time will move in front of the leader while still following the leader, and the time lag at this time will be offset with the time lag of the leader phenomenon where the follower really moves behind the leader, that is, the overall time lag tends to be neutral, so the two pairs of time series satisfying the negative bias phenomenon of CCF positive peak are relaxed to select the new optimal fixed time lag; the selected new optimal fixed time lag is then traded off with the DTW-aligned time lag series to obtain the optimal aligned time lag series; the following is the specific process of step II:

1. Obtaining the Optimal Fixed Time Lag

setting the time series X=(X(1), . . . , X(t), . . . ), Y=(Y(1), . . . , Y(t), . . . ) with maximum time lag δₘₐₓ∈N, where the fixed time lag l satisfies −δₘₐₓ≤l≤δₘₐₓ, l∈N; distorting the time series X at fixed time lag l as X^{l}=(X(1−l), . . . , X(t−l), . . . ), then the time lag that maximizes the degree of correlation between the two time series, i.e., the optimal fixed time lag, is:

$$L = {arg max}_{l} \vert sim ( {X}^{l} , Y ) \vert ,$$

where sim( ) is a function of similarity measurement between two time series, usually a correlation coefficient or covariance;

2. Obtaining DTW-Aligned Time Lag Series

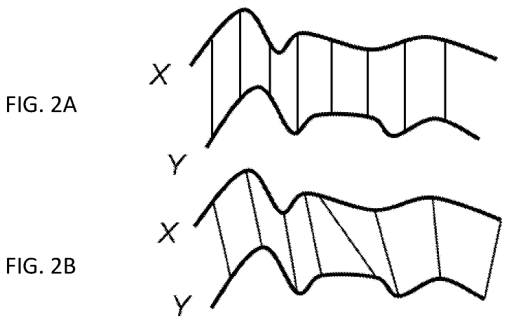

conventional Euclidean geometric distances are not effective in deriving the degree of similarity between two time series that “appear” similar (FIG. 2a), so before comparing the degree of similarity between the two time series, one of the time series should be “warped” under the time axis using the DTW algorithm to achieve better alignment (FIG. 2b);

setting the time series X and Y, obtaining a DTW-aligned time lag series P^{DTW} consisting the time lags of the two time series obtained by the DTW algorithm at each time point; where Y corresponds to X(t−P^{DTW}(t)) at moment t;

3. Finding CCF Positive Peak Negative Bias Phenomenon

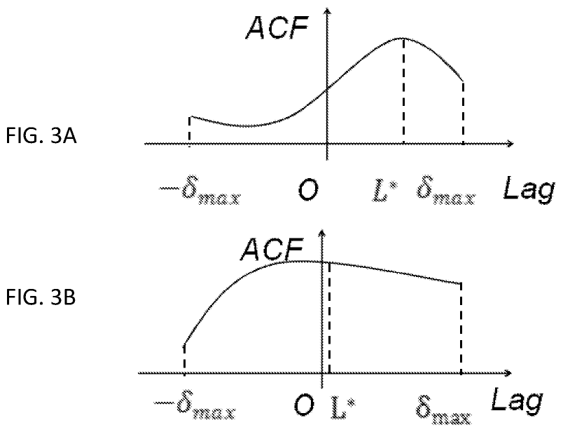

constructing function ACF(Lag) with Lag∈Z, where Lag is the time lag l of X and Y and ACF is sim(X^{l}, Y); the Lag−ACF(Lag) image of the function ACF(Lag) is called the CCF image (FIG. 3a);

the fixed time lag Lag can be positive or negative, when Lag is positive it means that Y follows X in step of Lag and when Lag is negative it means that X follows Y in the step of |Lag|;

letting the maximum time lag δₘₐₓ∈N, if

$${\sum }_{La ℊ = 1}^{{δ}_{max}} ACF ( La ℊ ) > {\sum }_{La ℊ = - {δ}_{max}}^{- 1} ACF ( La ℊ ) , {arg max}_{La ℊ} ACF ( La ℊ ) < 0 ,$$

then this pair of time series has CCF positive peak negative bias/phenomenon;

4. Relaxing the Optimal Fixed Best Time Lag

a relaxing coefficient of 0≤θ<1 is given when two time series have CCF positive peak negative bias; in the CCF image, in the first θ of all time lags Lag^{θ}={Lag₁, . . . , Lagᵢ, . . . , Lag_{|2θδ}_{ₘₐₓ}_{|}} ordered by the absolute value of the correlation degree ACF from largest to smallest, if

Σ_{Lag}_{ᵢ}_{>0}1−Σ_{Lag}_{ᵢ}_{<0}1>0,

then it is determined as the new fixed optimal time lag (FIG. 3b), where

$${L}^{*} = {arg min}_{La {ℊ}_{i}} i ,$$

otherwise L* is still L;

5. Optimal Aligned Time Lag Series

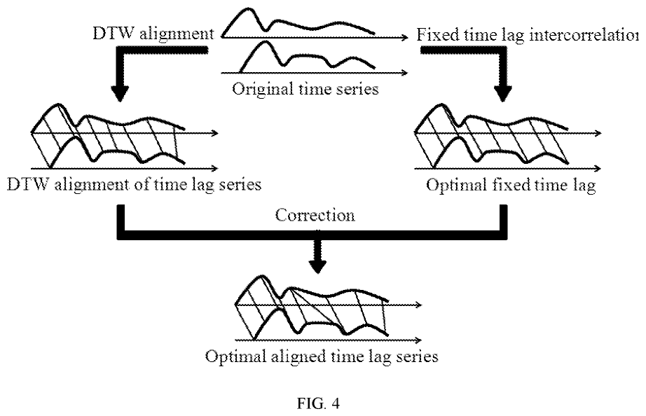

with DTW-aligned time lag series P^{DTW} of X and Y, the new optimal fixed time lag L* and the optimal alignment time lag at moment t (FIG. 4), where

$${P}^{*} ( t ) = \{ \begin{matrix}{L}^{*} , dist ( X ( t - {L}^{*} ) , Y ( t ) ) \leq dist ( X ( t - {P}^{DTW} ( t ) ) , Y ( t ) ) \\ {P}^{DTW} ( t ) , others\end{matrix}$$

then P*={P*(1), . . . , P*(t), . . . } is the optimal aligned time lag series, where dist ( ) is the distance function, and VL Granger Causality inference generally adopts Euclidean distance;

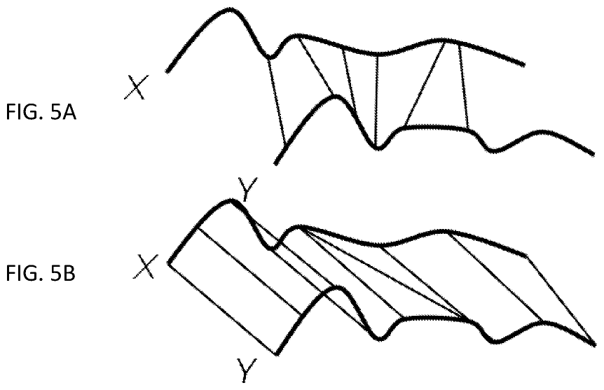

a certain pronounced time lag exists in the two time series discussed in terms of the VL Granger Causality inference; consequently, the optimal alignment will only be obtained locally if the DTW-aligned time lag series P^{DTW} is not corrected for the optimal fixed time lag L (FIG. 5a); whereas the optimal aligned time lag series P* of the two time series can be derived by taking into account the whole picture after correction (FIG. 5b); and

step III, distorting two time series using the optimal aligned time lag series and performing VL Granger Causality inference on these two, where a leader is considered to have a Granger Causality relationship of variable relaxed time-lag with the follower if the prior information of the leader's time series fits the current information of the follower's time series better than the prior information of the follower's time series; and a method of aligning similarity is also proposed to determine the following closeness of the follower to the leader.

Method 1 Comparison of the variance of the residuals

At moment t, the two residuals r_{Y} and r_{YX} resulting from regressing Y on past of X and regressing Y on past of X and past Y are

r_{Y}(t)=Y(t)−Σᵢ₌₁^{δ}^{ₘₐₓ}aᵢY(t−i), and

r_{YX}(t)=Y(t)−Σᵢ₌₁^{δ}^{ₘₐₓ}(aᵢY(t−i)+bᵢX(t−i));

a further residual of the regression is defined as:

r_{YX}*=Y(t)−Σᵢ₌₁^{δ}^{ₘₐₓ}(aᵢY(t−i)+bᵢX(t−i)+cᵢX*(t−i)),

where X is ‘distorted’ according to optimal aligned time lag series P* to obtain X*, where X*(t−i)=X(t−i+1−P*(t−i+1)); aᵢ, bᵢ and cᵢ are the optimal constants that minimize the residuals r_{Y}, r_{YX} and r_{YX}*; bᵢ and cᵢ are separated for the purpose of clearly representing the difference between the original Granger Causality and the VL Granger Causality, although they can be combined; if the variance of r_{YX}* is smaller than the variance of r_{Y} and the variance of r_{YX}, then it is considered that X VL Granger Causality leads to Y; and because the variance of r_{YX} is provably not greater than the variance of r_{Y}, the sufficient condition for X VL Granger to lead to Y is simplified to: need only the variance of r_{YX}* is smaller than the variance of r_{Y}.

Method 2 Similarity Alignment

Similarities of two time series X and Y are aligned as follows:

$$s ( P ) = \frac{{\sum }_{{Δ}_{t} ∈ P} sign ( {P}^{*} ( t ) )}{\vert P \vert} ,$$

where sign( ) is the sign function, and aligned similarity may be interpreted as the following closeness of Y to X.

Through the above technical schemes, results of Granger Causality inference of the active group collective movement are obtained, and the leader is selected according to the obtained results; then the leader movement trajectory is obtained according to the leader's position transformation at different times; robofish is released to learn the leader movement trajectory, that is, by controlling the machine fish to form the same movement trajectory as the leader, and simulating for a certain period; after that certain period, the fish is induced into a trap by the robofish by setting a right pace, where the right pace is set based on the location of the trap to achieve fish fishing.

The present application provides a method for causal inference based on collective movements of active group; which focuses on achieving causal inference of leadership phenomena in collective movements of active groups by improving the Granger Causality inference method with variable time lag into a Granger Causality inference method with relaxed time lag. The method of inference mainly includes aggregating time series, obtaining optimal aligned time lag series, and performing causal inference; considering that the overall time lag of the active group tends to be neutralized during collective movement leading to the insignificance of the optimal fixation time lag, accordingly, the present application relaxes the selection of the optimal fixed time lag in terms of selecting the optimal aligned time lag series, thus significantly improving the detection of active leadership phenomena; it is therefore possible to understand the strength of active individual responding to leadership interventions in the specific group environment they are in, and to understand the conditions for the occurrence of large-scale collective behavior at the micro level, and such an approach can be widely applied in marine fishing operations, where the fish are trained to obtain the movement trajectory of the characteristic group of fish firstly, then the active group leadership characteristics of the fish class are obtained according to the movement trajectory, and trained robofish are released to simulate the movement trajectory of the fish leader based on the obtained leadership characteristics, followed by setting a suitable pace so as to induce the fish into a trap, and the fishing efficiency is improved accordingly. The approach provided in the present application can serve as a source of inspiration and guidance for the production of real-life and help to develop solutions to relevant problems.

The above shows and describes the basic principles, main features and advantages of the present application. A person skilled in the art should understand that the present application is not limited by the above embodiments, and that the above embodiments and the description in the specification only illustrate the principles of the present application, and that there will be various variations and improvements to the present application without departing from the spirit and scope of the present application, which fall within the scope of the present application claimed for protection. The scope of protection claimed by the present application is defined by the appended claims and their equivalents.

What is claimed is:

1. A method for causal inference based on collective movements of active group, comprising:
obtaining a leader time series and a follower time series for collective movements of an active group;
obtaining a fixed time lag, obtaining an optimal fixed time lag based on the obtained fixed time lag; obtaining an aligned time lag series based on the obtained leader time series and the obtained follower time series; relaxing the obtained fixed time lag, updating the obtained optimal fixed time lag based on a result of the relaxing; obtaining an optimal aligned time lag series based on the obtained aligned time lag series and the updated optimal fixed time lag; and
distorting the leader time series and the follower time series based on the optimal aligned time lag series, performing Granger Causality inference on the distorted leader time series and the follower time series, and obtaining a result of Granger Causality inference of the active group collective movement; obtaining a leader movement trajectory based on the result of Granger Causality inference of active group collective movement, releasing a robofish to learn the leader movement trajectory, and setting pace of the robofish to enable fish harvesting.

2. The method according to claim 1, wherein obtaining leader time series and follower time series for collective movements of active group comprises a process below:
obtaining a number of initial leader time series and a number of initial follower time series of the movements of the active group, and obtaining the leader time series and follower time series by aggregating the initial leader time series and follower time series, respectively;
wherein the initial leader time series and the initial follower time series comprise parameters of a movement direction and acceleration.

3. The method according to claim 1, wherein the optimal fixed time lag is obtained specifically by:
distorting the leader time series based on the fixed time lag, performing intercorrelation degree analysis on the follower time series and the distorted leader time series, and obtaining the optimal fixed time lag based on the results of the intercorrelation degree analysis;
wherein the optimal fixed time lag is the fixed time lag corresponding to the maximum degree of intercorrelation in the results of the intercorrelation degree analysis.

4. The method according to claim 1, wherein the aligned time lag series is obtained by:
normalizing the leader time series by means of a dynamic time warping algorithm, aligning the normalized leader time series with the follower time series, performing a time lag calculation on the follower time series and the normalized leader time series based on an alignment result, and obtaining the aligned time lag series based on a result of the time lag calculation.

5. The method according to claim 1, wherein relaxing the obtained fixed time lag is preceded by:
distorting the leader time series by fixed time lag, measuring similarity of the follower time series and the distorted leader time series, constructing a correlation function based on the follower time series and the measured similarity, determining numerically based on the constructed correlation function and obtaining a determination result; and
relaxing the fixed time lag if the determination result satisfies a determination condition; otherwise, performing no relaxing and directly obtaining the optimal aligned time lag series based on the aligned time lag series and the optimal fixed time lag.

6. The method according to claim 3, wherein updating the obtained optimal fixed time lag comprises:
constructing a relaxing coefficient, ranking fixed time lags according to absolute values of the results of intercorrelation degree analysis based on the relaxing coefficient to obtain a relaxed time lag series, wherein the relaxed time lag series includes several relaxed time lags; and
selecting a smallest relaxed time lag in a positive range of the relaxed time lag series to update the optimal fixed time lag.

7. The method according to claim 6, wherein updating the optimal fixed time lag is further preceded by:
determining the relaxed time lag based on the relaxed time lag series and updating the optimal fixed time lag is a number of positive numbers in the relaxed time lag is greater than a number of negative numbers in the relaxed time lag; and
otherwise, performing no updating on the optimal fixed time lag and obtaining the optimal aligned time lag series directly based on the aligned time lag series and the optimal fixed time lag.

8. The method according to claim 1, wherein performing Granger Causality inference on the distorted leader time series and the follower time series includes:
performing residual variance comparison based on distorted results for Granger Causality inference, and obtaining Granger Causality inference results for collective movement of active groups.

9. The method according to claim 1, wherein performing Granger Causality inference on the distorted leader time series and the follower time series is further followed by:
obtaining a following closeness of followers to leaders by performing a similarity calculation on the distorted results, and supplementing the results of Granger Causality inference for the collective movement of active groups based on the following closeness.
